(19) United States
(12) Patent Application Publication
(10) Pub. No.: US 2003/0112639 A1
(43) Pub. Date: Jun. 19, 2003

(54) LED based optical fiber illuminator and controller

(76) Inventor: Michael Stack, Chicago, IL (US)

Correspondence Address: CHAPMAN AND CUTLER, 111 WEST MONROE STREET, CHICAGO, IL, 60603, US

(21) Appl. No.: 10/321,881

(22) Filed: Dec. 17, 2002

Related U.S. Application Data
(60) Provisional application No. 60/341,970, filed on Dec. 18, 2001.

(51) Int. Cl. F21V 8/00

(52) U.S. Cl. 362/552; 362/231; 362/555; 362/580

(57) ABSTRACT

A compact, long-life illuminator for an optical fiber or bundle of fibers uses an array of light-emitting diodes (LEDs) to selectively illuminate and color such fibers from within an enclosure which may be a compact, multipurpose, sealed housing. The illuminator is composed of solid-state components with no moving parts. It performs in several lighting and signage applications and has a surprisingly long life. The brightness and color of the light output from the LEDs, and changes in same over time in pre-set or variable cycles, can be set, changed, and carried out through an internal or external control board. That control board can be used in combination with an external digital multiplex (DMX) device, either hard wired or wirelessly controlled, and may be programmed by a computer system operating through a data bus management system.

### CLAIM TO PRIORITY

The priority of co-pending provisional application serial No. 60/341,970, filed Dec. 18, 2001, is herewith claimed.

### FIELD OF THE INVENTION

The present invention relates to illuminators and control systems for fiber optic lighting and signage, and particularly to systems with color changing capabilities.

### BACKGROUND OF THE ART

Fiber optic systems are known for both end lighting and side lighting applications, in residential, commercial, industrial, and other lighting uses and in signage. Such systems, configured either as end lights for spot lighting or as side lights for architectural decoration and signage, comprise optical fibers and bundles of fibers for transmitting light from a remote source to an end point or by leakage along the fiber to an area of application; and illuminators that provide light into the fiber at one end thereof that is steady or can be modulated in color and/or intensity. Such illuminators have typically been electromagnetic in nature, each having a halogen or high intensity discharge bulb, optionally a motorized color wheel, a ballast for properly powering the bulb, and a cooling fan to maintain proper temperatures. The elements are housed in a shoebox sized metal cabinet, with an external power source. These devices are generally not useable outdoors or in extreme environments, the various components (bulb, motor, etc.) have limited useful life spans, and the displays are not versatile.

### SUMMARY OF THE INVENTION

An object of the invention is to provide a versatile, compact, indoor/outdoor fiber optic light source or illuminator using solid-state components for exceptionally long life and a variety of practical applications. The illuminator and its control system are comprised entirely of solid-state components, which may be set within a housing which is fitted to the end of an optical fiber or bundle of fibers opposite a base of the housing.

An array of light-emitting diodes (LEDs) in the base of the illuminator, comprising green, red, blue, and optionally white LEDs, provides light of selected, controllable color and intensity to an end of an optical fiber or bundle of fibers. An illuminator may be used at each end of a “leaky” optical fiber or bundle that is used for side-lighting applications. The light of each illuminator may pass through a focusing lens to be directed to the end of the optic fiber or bundle, or the interior of the head of the housing can be made highly reflective, or both. The base of the housing may also enclose, behind the LEDs, a control board, a heat shunt, and/or a power source; these components may alternatively be separate from any housing or be omitted in particular applications.

The control board is a solid state, programmable device for setting or changing the intensity, color, and sequence of the LED illumination. The control board can be preprogrammed or be user programmable. Programming the colors, sequence, and intensity of the LEDs allows any of a wide range of colors to be supplied to the end(s) of the optic fiber. The control board may incorporate an erasable programmable read-only memory (EPROM) or other storage device within its circuitry. The EPROM or other storage device will also regulate current to the LED or the LEDs of an array, controlling which ones turn on and their intensities, and also protecting them from any power surge. The base may include an on/off switch or may receive power from an external source.

The head and base of the illuminator housing, if used, are held together with finger operated joining clips. O-rings are provided about the optic fiber and the base-head junction to ensure weather tightness. The illuminator can function in an entirely self-contained mode with its own power source, control board, and optional on/off switch, requiring no hard wiring. The illuminator is also operable with a hard-wired power source to provide service without the limitation of the life of an internal power supply. The control board can be programmed to modify the color and intensity of the light in combination with an external DMX.

The combinations of various components provide for both effective, relatively simple color applications as well as long term, relatively complex and specialty applications, both indoors and out.

### BRIEF DESCRIPTION OF THE DRAWINGS

FIG. 1 is a cutaway, longitudinal cross-section of an illuminator housing and an optical fiber end in accordance with one form of the present invention.

FIG. 2 is a plan view of the LED array in one embodiment.

FIG. 3 is an overview block diagram of one control system used in the invention.

FIG. 4 is a schematic representation of drive electronics for the system of the invention.

### THE PREFERRED EMBODIMENTS

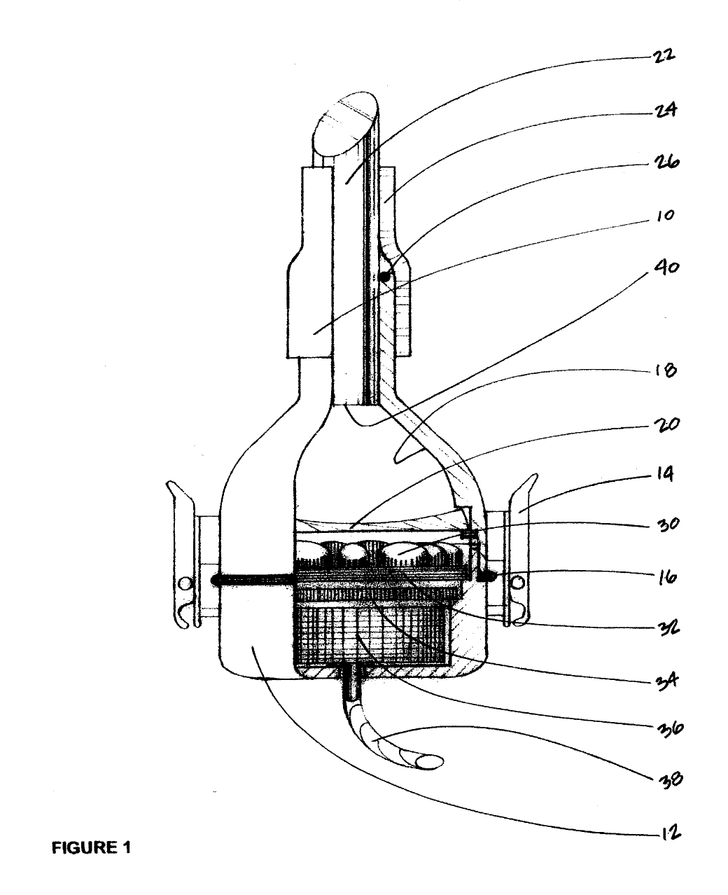

An illuminator housing assembly shown in FIG. 1 comprises a head 10 and base 12 connected by means of joining clips 14, with an O-ring 16 fitted between them to ensure weather tightness. The head 10 has a highly reflective internal surface 18, a focusing lens 20, an opening to accommodate an optic fiber 22, a flexible sleeve 24 to seal and strengthen the fiber optic/head attachment, and an O-ring seal 26 between the cable 22 and the head 10. The base 12 houses an LED array 30, comprising a plurality of individual LEDs, that is attached to a control board 32 and a heat sink or shunt 34. Power to operate the control board 32 and the LED array 30 is provided by either or both of an internal power supply 36 and an external hard-wired power connection 38, both fitted for weather-tightness. The system may also be readily adapted for underwater, high altitude, and space or orbital use. Connection 38 can also provide control signals for the board 32 and the LED array 30. An optional on/off switch (not shown) may also be provided. The fiber 22 can be a bundle of fibers, and an illuminator can be provided at opposite ends of an optical fiber that is “leaky” for longer side-lighting uses.

The assembly head 10 preferably can be fitted with different sizes of openings (e.g., of 5 mm, 10 mm., etc. diameters), as via the flexible boot 24, to accept optical fibers or bundles of fibers of different sizes or natures. Light produced by the LED array 30 passes through the focusing lens 20 inside the reflective wall 18 of the housing head 10 and impinges on the one end of the optic fiber 22. The light passes through the fiber 22 to its remote end, in one application of the invention, or leaks out of the fiber 22 along its length, as in a neon or fluorescent tube, in another form.

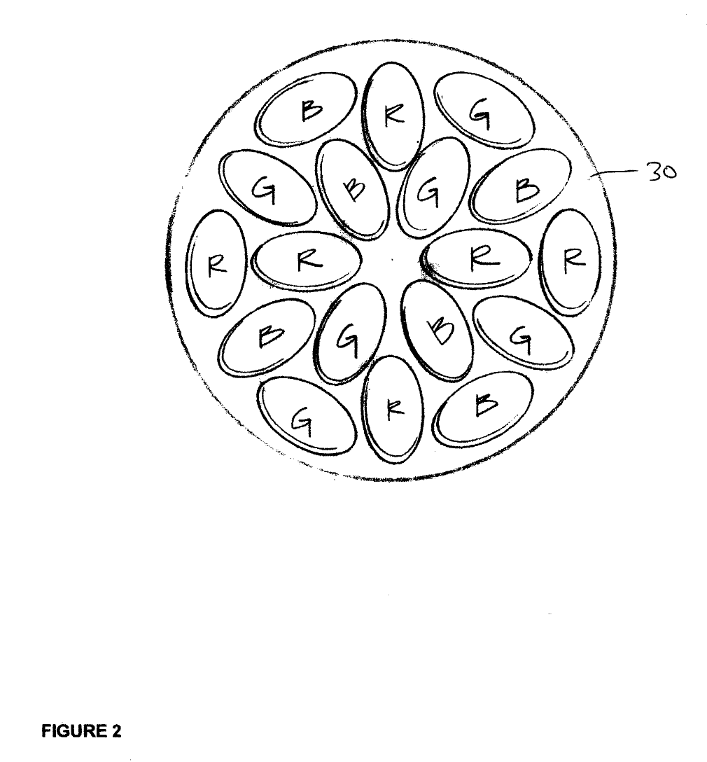

The LED array 30 comprises any selected number of LEDs, arranged for instance as shown in FIG. 2. Each LED is powered in this embodiment through the control board 32 from the power supply 36 or wire 38. The array 30 can be configured and operated to provide a single color, any number of discrete colors, or any mix and shading of colors. The control board 32 can be operated by a Digital Multiplexing unit, a “DMX”, which can be either hard wired to a computer for flexible reprogramming or be radio operated. By providing both an internal power supply 36 and a hard wire 38 to an external source, the illuminator can operate in several different modes: pre-programmed and self-contained with a replaceable or rechargeable battery and optional on/off switch, hard wired, or hard wired with an external DMX operating control together with the control board 32. The control board 32 may be omitted from the housing if, for instance, a computer system is used to control and power the LEDs.

The LED array 30 further comprises any selected colors, sizes, and locations as is designed to provide the desired light outputs (single color, multicolor, etc.). LEDs are available in a wide range of sizes, maximum light intensities, and colors, for producing different effects. Their technology and functions are continually being improved upon, being now widely used for instance in automobile brake lights where their fast-on feature and long life are important. Each LED in array 30 is attached to the control board 32 through a computer chip which controls it, modulating its on-off state over time and its intensity while on, as directed by the control board 32 and its programming. In a self-contained mode, the control board performs all the light production functions and is powered by an internal supply. For prolonged operation, the assembly is fitted with a weather proof, if required, or other wire 38 that supplies power to the control board 32 for less complex operations or together with an external DMX for establishing more complex operations.

Conventional fiber optic illuminators produce their colors in a very limited fashion, using a mechanical color wheel or a gel of a single color. The virtually limitless color possibilities of the LED illuminator of this invention present a distinct advantage over existing illuminators. The array 30 in one embodiment includes red (R), green (G), and blue (B) LEDs arranged as shown and optionally mounted in a tilted orientation toward an inward end 40 of the optic fiber 22. White LEDs, not shown, can be included in the array to add brightness to the colored light produced by the array. Larger LEDs, of up to 15 and 20 mm diameters, have more color intensity and output than smaller ones but presently tend to generate more heat than similar but smaller LEDs.

The heat shunt 34 is provided to absorb the relatively small amount of heat produced by the LEDs and to pass the heat to the housing base 12 for dissipation to the surroundings. The heat shunt 34 also protects the control board 32 in a similar fashion. In conventional fiber optic illuminators, the heat generated by the light source, as a halogen or high-intensity discharge bulb, is a considerable problem, requiring fans or active cooling systems to maintain their operation. The LEDs used in the present illuminator create far less heat than halogen or HID systems.

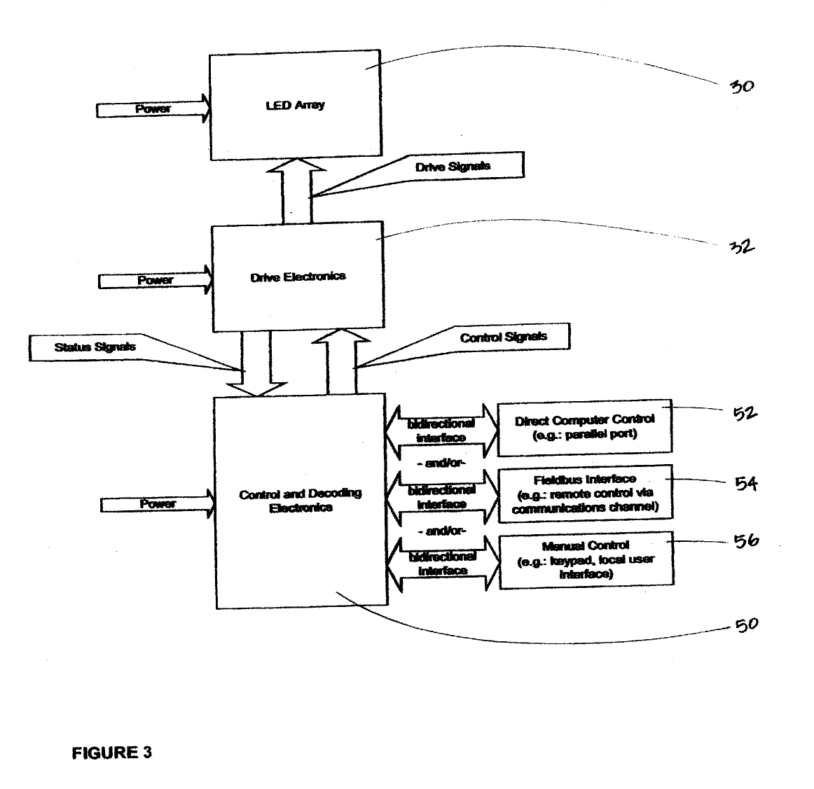

FIG. 3 depicts in schematic fashion various control and input systems useable with the present invention. The LED array 30 is powered from the battery 36 and/or the wire 38 and is controlled by drive signals from the drive electronics in the control board 32. The control board is similarly powered from the battery 36 and/or the wire 38. The control board 32 is controlled, for set-up and/or for continuous variation of signals, by control signals from a DMX system or similar control and decoding electronics system 50, and in turn provides status signals back to the control system. The DMX or other electronics system 50 is generally situated externally to the housing 10, 12 of the illuminator of FIG. 1, and may control a plurality of such illuminators simultaneously. The electronics system 50 in turn is controlled by any of three or more interface systems. A direct computer control 52 acting through a parallel, serial, or UBS port may interact with the system 50. A fieldbus interface 54 may control the electronics 50 through a wired channel or a radio, infrared, or other remote or wireless connection. Third, a manual control 56 as a keypad, slide switches, or other control device may be used locally for fixing or adjusting the light color and intensity of the LED array 30.

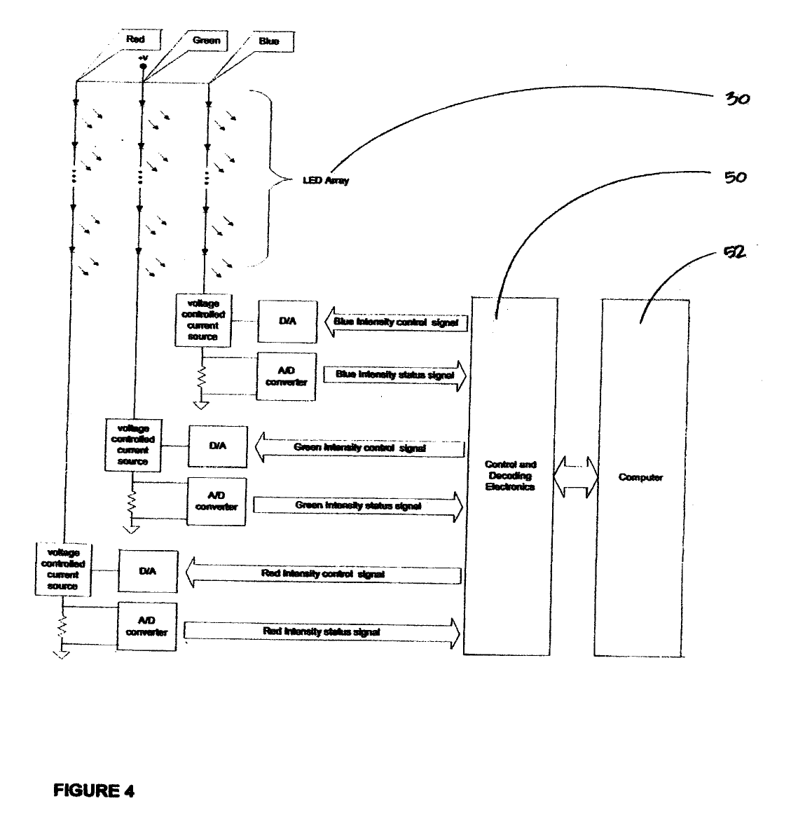

FIG. 4 shows a more detailed electrical schematic of the arrangement of the individual LEDs of the array 30 with respect to the control and decoding electronics system 50 and the computer controller 52. Each string of LEDs of a given color, red, green, or blue, as shown, is connected in series to a voltage source shown as +V through a voltage controlled current source and a selected resistance to ground. LEDs of a given color may alternatively be connected in parallel strings for greater intensity, each parallel branch having a selected, balancing resistance if necessary for uniformity of the light from each string. The D/A converters provide the control voltage to the LED current source for each color respectively. The matching A/D converter, attached across a dropping resistor, provides the feedback signal for the control system so as to monitor the response of the LED, LEDs, or LED array to the originating command processed by the D/A converter. This control strategy is one of several possible arrangements for LED intensity and color control.

The invention as described can function in a variety of applications; for signage with a single optical fiber or a bundle of optical fibers, with an illuminator at either end of the fiber optic as an extended architectural element, as specialty items that require a number of optical fibers to be lit with sequenced colors simultaneously, and the like. These applications and variations noted above and others which may be developed with this disclosure in mind will not necessarily depart from the principles of the invention pictured and described herein and claimed as my invention.

I claim as my invention:

1. A solid state illuminator for lighting an optical fiber, the illuminator comprising:
an enclosure having one part that is fitted to and about an end of the optical fiber;
an array of light emitting diodes located within an opposite part of the housing thereof and arranged to provide light to the end of the optic fiber;
a programmable control board means for selectively applying power to the LEDs; and
a power supply connected to the control board and to the LED array.

2. The solid state illuminator defined in claim 1, wherein the control board means operates the LEDs to produce light of a desired intensity and color.

3. The solid state illuminator defined in claim 1, wherein the control board means is programmed to operate at least one LED in the array of LEDs independently of others.

4. The solid state illuminator defined in claim 1, wherein the control board means is located within the assembly.

5. The solid state illuminator defined in claim 1, wherein the control board means is operable via an external digital multiplex (DMX) controller.

6. The solid state illuminator defined in claim 5, wherein the control board means is hard wired to the DMX.

7. The solid state illuminator defined in claim 5, wherein the control board means is wirelessly controlled from the DMX.

8. The solid state illuminator defined in claim 1, further comprising a heat shunt located within the enclosure adjacent the control board means, for transmitting heat away from the control board means and the LED array.

9. The solid state illuminator defined in claim 1, wherein an external power supply is provided to power the illuminator via a hard wire.

10. The solid state illuminator defined in claim 1, further comprising a lens positioned adjacent the LEDs to direct the light therefrom onto the end of the fiber optic.

11. The solid state illuminator defined in claim 1, wherein the enclosure is useable with sleeves to accommodate different sizes of optical fibers.

12. The solid state illuminator defined in claim 1, wherein the optical fiber comprises a bundle of fibers for transmitting light from the illuminator.

13. The solid state illuminator defined in claim 1, wherein the enclosure has a highly reflective interior surface adjacent the LED array and the optical fiber.

14. The solid state illuminator defined in claim 1, wherein the LED array comprises a plurality of LEDs of selected sizes and maximum light intensities, and of green, red, and blue colors.

15. A solid state illuminator having a long life and low-temperature operation, for injecting into an end of an optical fiber light of selected color and intensity, the illuminator comprising:
a hollow housing adapted to be fitted to an end of the optical fiber;
an array of light-emitting diodes fixed in the housing and oriented to provide said light to the end of the fiber;
a controller for said LED array for varying at least one of the color and the intensity of the light emitted therefrom; and
control means for adjusting the controller at least once to provide light of a selected color and intensity from the illuminator to the fiber.

16. The solid state illuminator defined in claim 15, wherein the LED array comprises at least one each of red, blue, and green LEDs.

17. The solid state illuminator defined in claim 15, wherein the illuminator further comprises a lens for gathering light from the LEDs and directing it to the end of the optical fiber.

18. The solid state illuminator defined in claim 15, wherein the control means is in wireless communication with the controller for said array of LEDs.

19. The solid state illuminator defined in claim 15, wherein the control means comprises direct computer control of the controller.

20. The solid state illuminator defined in claim 15, wherein the control means comprises a fieldbus interface with the controller.

21. The solid state illuminator defined in claim 15, wherein the control means comprises manual control of the controller.
